(19) United States
(12) Patent Application Publication
(10) Pub. No.: US 2010/0101833 A1
(43) Pub. Date: Apr. 29, 2010

(54) ABRASION RESISTANT CORDS AND ROPES

(75) Inventors: Nina Zachariades, Hillsborough, CA (US); Dimitris J. Zachariades, Hillsborough, CA (US)

Correspondence Address: EDWARD S. SHERMAN, ESQ., 3554 ROUND BARN BLVD., SUITE 303, SANTA ROSA, CA, 95403, US

(73) Assignee: POLTECO INC., Burlingame, CA (US)

(21) Appl. No.: 12/579,344

(22) Filed: Oct. 14, 2009

Related U.S. Application Data
(60) Provisional application No. 61/107,864, filed on Oct. 23, 2008.
(60) Provisional application No. 61/218,875, filed on Jun. 19, 2009.

(51) Int. Cl. H01B 7/24; D07B 1/04; B32B 27/32

(52) U.S. Cl. 174/136; 428/375; 428/394; 428/222; 156/60

(57) ABSTRACT

The abrasion resistance of organic fiber based ropes and cords is increased by a outer woven cover of tapes of high molecular weight and more preferably ultrahigh molecular weight polyethylene.

### CROSS REFERENCE TO RELATED APPLICATIONS

The present application claims priority to the US provisional patent application having Ser. No. 61/107,864 that was filed on Oct. 23, 2008, which is incorporated herein by reference.

The present application also claims priority to the US provisional patent application having Ser. No. 61/218,875 that was filed on Jul. 19, 2009, which is incorporated herein by reference.

### BACKGROUND OF INVENTION

This invention relates to a covering device and a coating material comprising high or ultra high molecular weight polyethylene (UHMWPE). The invention is also directed to cord-like devices such as ropes, cords, cables, coatings, strands, fibers, tapes, etc. with superior abrasion resistance, reduced weight and diameter, comprising the covering device or the coating material mentioned above.

New ropes are continually being developed to meet the needs of specialized applications. Through rope engineering, it is possible to design a rope with specific performance characteristics. These characteristics are met by changing materials and construction methods. Decisions as to what factors are important must be made.

In a practical sense, advantages and disadvantages must be traded off and compromises must be made to design the best rope for a given application.

Some applications require: Strong low-elongation ropes for rescue; Shock-absorbing ropes for the rock climber; Floating ropes for marine uses and river rescue; Low-elongation, shock absorbing ropes for caving and arborists; Soft responsive rappel ropes; Colored rope for multi-rope management challenges; and Superior strength, non stretching buoyant ropes for marine applications.

In general, ropes are constructed with multifilament fibers in three strands twisted together or in various braided forms, such as braid with or without a core and double braid. The various multifilament fibers used in rope manufacturing are predominantly synthetic and made of polymers such as polyamides (e.g. Nylon), polyesters (e.g. Dacron®, polypropylene, polyethylene (e.g. Dyneema® and Spectra®), aromatic polyamides (e.g. Kevlar®, Twaron®) and aromatic co-polyesters (e.g. Vectran®).

Depending on the intended purpose of the rope, different polymer fibers are used; polyamides for their stretching and shock absorbing capability, polyesters for their UV and abrasion resistance, polypropylene for its lightness and low cost, polyethylene and aromatic polyamides for their high strength and low extension.

However, these commonly used rope fibers also have certain disadvantages that are associated with their particular chemical structures. Polyamides and to a lesser extent polyesters absorb water, polyamides and polypropylene are susceptible to UV degradation, and aromatic polyamides are susceptible to fatigue bending.

Also, whereas some of the rope fibers have higher abrasion resistance than others, e.g. polyesters over polyamides, ultra high molecular weight polyethylene over aromatic polyamides, all ropes made of bundles of multifilament fibers wear out with abrasion against other materials encountered during their use and fray as the filaments comprising the bundles of multifilaments are laterally very weak because of the weak bonding between adjacent filaments and become loose and break down into weaker microfibrils, a process that leads to the destruction of the rope.

In order to obtain the benefit of individual polymer properties and manage the cost of the ropes particularly those containing the costly high strength fibers of ultra high molecular weight polyethylene and aromatic polymers, manufacturers combine different polymer fibers for the construction of hybrid ropes, for example a high strength ultra high molecular weight polyethylene or aromatic polyamide as a core with a less expensive polyamide, a UV resistant polyester or a light weight polypropylene as a braided outside layer to protect the high strength core component.

This outside layer, or protective cover, is used to protect the high strength performance core component for reasonable lengths of time, and can be used in proportions of 40-60% of the total weight of the rope for example. It contributes a significant amount to the weight of the rope for the role of protection as well as to the overall volume of the rope, as the diameter is typically substantially larger than that of the core component. This protective layer can make the rope heavier, bulkier and more difficult to handle.

Therefore, there is a need in the industry for a covering device or a coating material that responds to at least one drawback of what is known in the field. More particularly, there is a strong need for a new covering material or coating allowing the manufacture of a new generation of ropes that can provide high mechanical performance and other useful attributes such as floating capabilities with enhanced abrasion resistance and hence longer service lifetime in smaller diameters and lower weights than currently used traditional ropes.

### SUMMARY OF INVENTION

The present invention responds to the above need by providing a covering device or a coating material having: enhanced abrasion resistance properties; reduced volume; and/or -floating capability.

More particularly, according to a first preferred aspect, the invention relates to a covering device or a coating material which comprises a braid or woven construction of high molecular weight polyethylene unitary filaments in the form of a tape with continuous and coherent structure. By tape, we mean an elongated member having a substantially flat cross-section in which the width is much greater than the thickness. While the members may have a high elastic modulus and/or strength, the thickness is sufficiently thin that the material can be bent for shaping and weaving into a covering member around rope, cords and lines having a diameter that is larger than the tape width. Preferred dimensions for such tapes are provided elsewhere in the specification and in specific examples.

According to another preferred aspect, the invention also relates to a cord-like device having enhanced abrasion resistance properties and/or reduced volume and/or floating capability. The cord-like device comprises an interior cord surrounded by an exterior covering including a braid or woven construction of high molecular weight polyethylene unitary filaments in the form of a tape with continuous and coherent structure.

According to another preferred aspect, the invention relates to a cord comprising a plurality of parallel, braided, twisted or woven strands, cables, ropes, wires, coils or laces made of a plurality of parallel, braided, twisted or woven tapes. The tapes comprise high molecular weight polyethylene unitary filaments with continuous and coherent structure.

More preferably, the high molecular weight polyethylene mentioned above has a molecular weight greater than 300,000, and even more preferably greater than 3 millions.

According to another preferred aspect, the invention relates to the use of a covering device as defined above, for covering a cord.

According to another preferred aspect, the invention relates to the use of a coating material as defined above, for coating a cord.

According to another preferred aspect, the invention relates to a process for the manufacturing of a cord-like device as defined above. The process comprises the steps of:

a) providing an interior cord; and

b) applying an exterior covering around the interior cord to form the cord-like device.

These and other features of the present invention will become more apparent from the following description. The above and other objects, effects, features, and advantages of the present invention will become more apparent from the following description of the embodiments thereof taken in conjunction with the accompanying drawings.

### BRIEF DESCRIPTION OF THE DRAWINGS

FIG. 1A is a cross-section elevation of a first embodiment taken transverse to the principle axis of the cord or rope.

FIG. 1B is a partial cut-away exterior elevation transverse to the cord or rope on FIG. 1A

FIG. 2 is a cross-section elevation of another embodiment taken transverse to the principle axis of the cord or rope.

FIG. 3 is a cross-section elevation of another embodiment taken transverse to the principle axis of the cord or rope.

FIG. 4 is a cross-section elevation of another embodiment taken transverse to the principle axis of the cord or rope.

FIG. 5 is a cross-section elevation of another embodiment taken transverse to the principle axis of the cord or rope.

### DETAILED DESCRIPTION

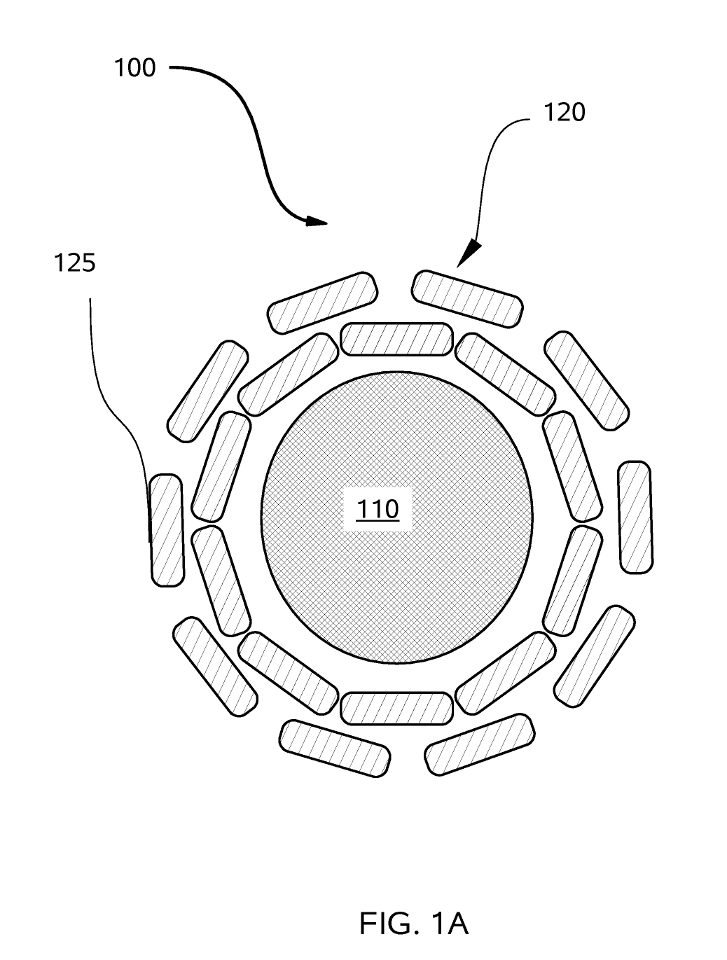

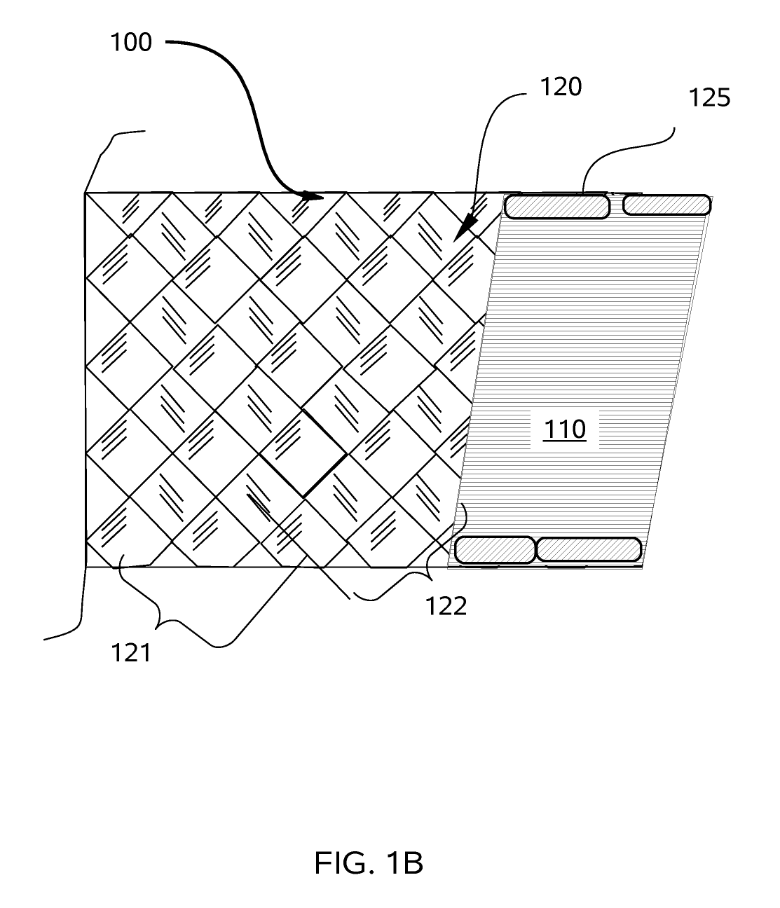

Referring to FIGS. 1 through 5, wherein like reference numerals refer to like components in the various views, there is illustrated therein a new and improved cord, rope or cable, generally denominated 100 herein.

As stated above, the present invention is first directed to a covering device or a coating material having enhanced abrasion resistance and their respective use for the making of cords or cord-like devices covered by the covering device or coated by the coating material.

The enhanced abrasion resistance is attained by the use of a covering device or coating material comprising a braided or woven construction of UHMWPE unitary filaments with continuous and coherent structure unlike the bundles of multifilament fibers known to be currently in use.

UHMWPE, a polyethylene with an ultra high molecular weight, is known to have the highest abrasion resistance among most of the important thermoplastic polymers and metals. Also, within the UHMWPE family of polyethylene, it is known that the abrasion resistance of UHMWPE increases with its molecular weight. Hence, an UHMWPE that is used in the manufacturing of tapes for the exterior covering of braid or woven layer may not necessarily be the same with the UHMWPE that is gel or solution spun for making the high strength interior core component. The term UHMWPE refers to the UHMWPE as defined by the ASTM-D4020-81 and for the purposes of this application, it includes polyethylenes with a molecular weight of at least 300,000; or higher such as 3 millions or higher.

High strength UHMWPE fibrillar tapes having a continuous coherent structure can be produced from melt crystallized, pseudo-gel and compacted powder precursors as described in prior art U.S. Pat. Nos. 4,587,163; 5,407,623 and 5,479,952, which are incorporated herein by reference. A common characteristic of the processes used in making the UHMWPE unitary is that they do not involve fiber spinning procedures that lead to multifilament fibers. The UHMWPE unitary tapes are made of oriented and extended molecular chains connected by molecular entanglements that make the fibrillar tapes coherent and with a continuous structure unlike the multifilament fibers that fray.

Such unitary and fibrillar tapes were used for constructing different braid forms and ropes.

In alternative, but currently less preferred embodiments the tapes may be formed from HMWPE by melt extrusion in the form of a tape, but more preferably some combination of first melt extrusion and then either drawings or solid sate extrusion through a die having a tape shaped cross section to provide at least some molecular orientation to the polyethylene molecules to increase the strength and abrasion resistance of the tape. Such tapes preferably have a fibrillar structure, but are essentially unitary in the sense that the boundaries between the fibrils and micro-fibrils are not weak and the tape itself is fray and abrasion resistant.

It should also be appreciated that terms HMWPE and UHMWPE can also embrace compositions initially formed form lower molecular weight PE that is increased in molecular weight by cross-linking, either by irradiation or chemical cross-linking agent, as for example after extrusion but before or the fabrication to the final dimensions of the tape.

Because of their shape, tape as compared to a bundle of fibers twisted into a substantially bulkier thread, the resultant braid construction of the UHMWPE tape was also substantially thinner, which can result in a cord-like device with a reduced diameter and volume. The enhanced abrasion resistance of the UHMWPE unitary tapes reduces the required amount of material for the exterior coating and results in reduced volume and weight.

The present invention relates also to a cord-like device 100 having enhanced abrasion resistance properties as it comprises an interior cord 110 surrounded by an exterior covering 120, as shown in FIGS. 1A and 1B. The exterior covering comprises high molecular weight polyethylene, and preferably UHMWPE.

As further shown in FIG. 1B, the exterior covering of the cord-like device mentioned above is made of a braid or woven construction of ultra high molecular weight polyethylene unitary filaments in the form of a tape 125 with continuous and coherent structure, having at least two sets of parallel tape members 121 and 122 interwoven to alternatively overlap each other, and in this embodiment each set being disposed generally at about 90 degrees to the other set and 45 degrees with respect to the principle or longitudinal axis of the cord 100. It will be appreciated that the angle of the wrapping and the number of layers can be varied from this example without departing from the scope and spirit of the invention as defined in the claims that follow.

The above mentioned cord-like device comprises an interior cord 110. By the term “cord”, it has to be understood any sort of linear or longitudinal material such as, but not limited to, strands, ropes, cables, wires, coils, laces or the like. The cord is generally made of a plurality of fibers or tapes, preferably made of a plurality of parallel, braided, twisted or woven fibers or tapes.

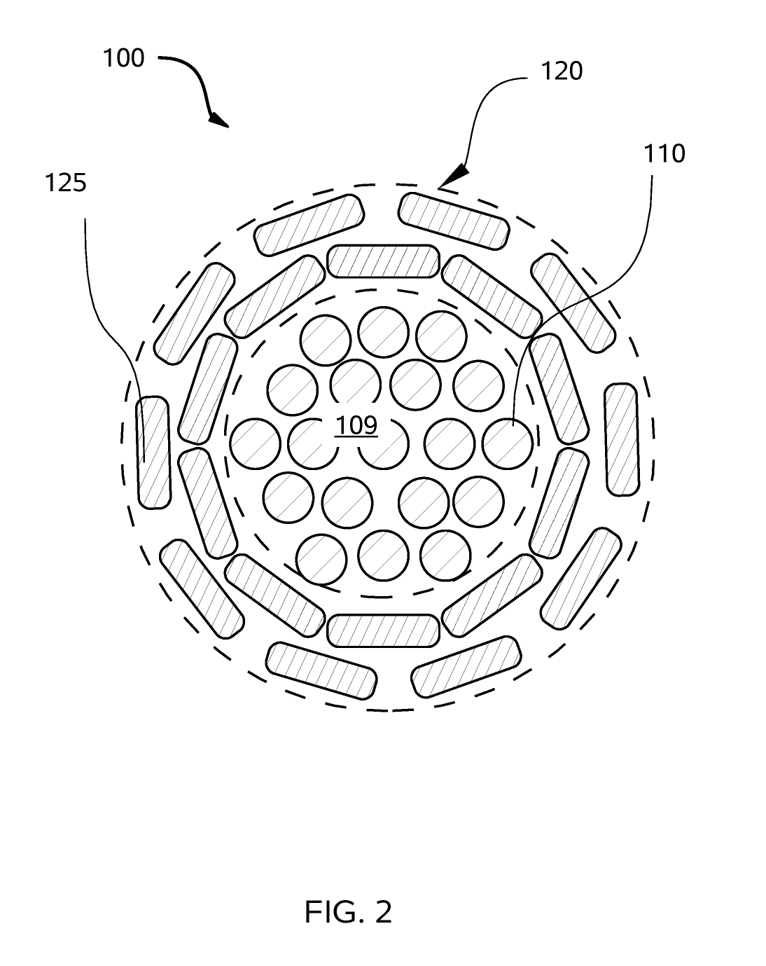

The interior cord 110 may also comprise a plurality of parallel, braided, twisted or woven strands, cables, ropes, wires, coils or laces made of a plurality of parallel, braided, twisted or woven fibers or tapes, generally illustrated as 109 in FIG. 2.

The fibers or tapes may be high strength polymer fibers or tapes, or high strength fibers or tapes made of metal or metal wires.

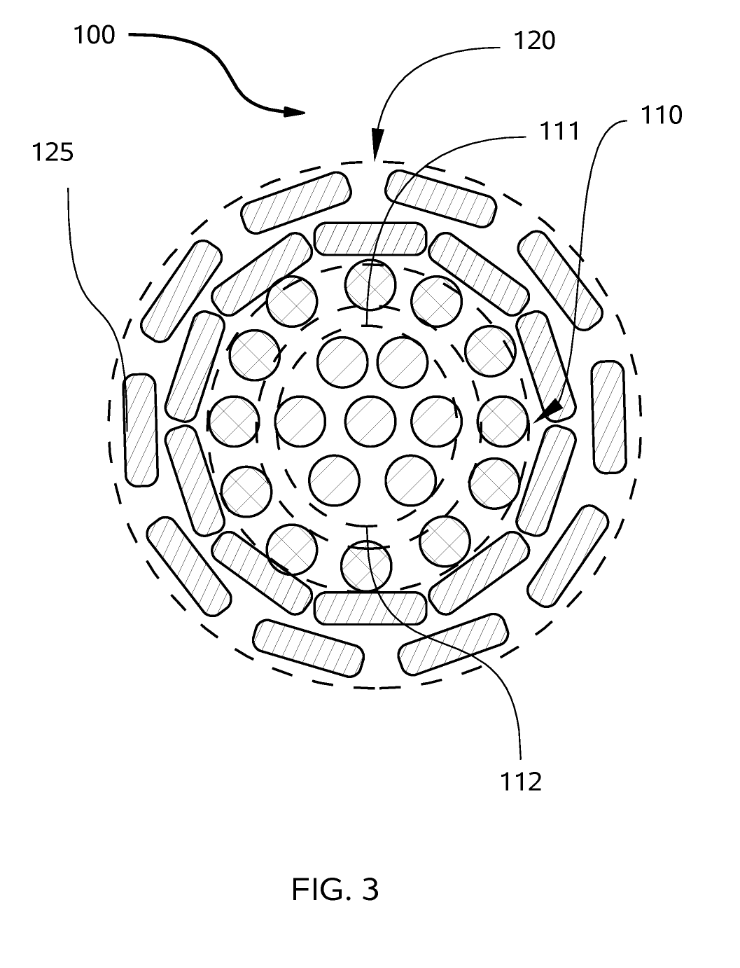

As for example in FIG. 3, the interior cord 110 has a first set of fibers 111 surrounded by a second set of fibers 112 which is then covered by the braided exterior cover of woven HMPE or UHMWPE 125 formed of tapes 120.

The polymer fibers and tapes may be high strength multifilament fibers or tapes comprising at least one polymer selected from; but not limited to, the group consisting of ultra-high molecular weight polyethylene, polyethylene, polypropylene, polyamide, polyester, aromatic polyamide, and aromatic copolyester.

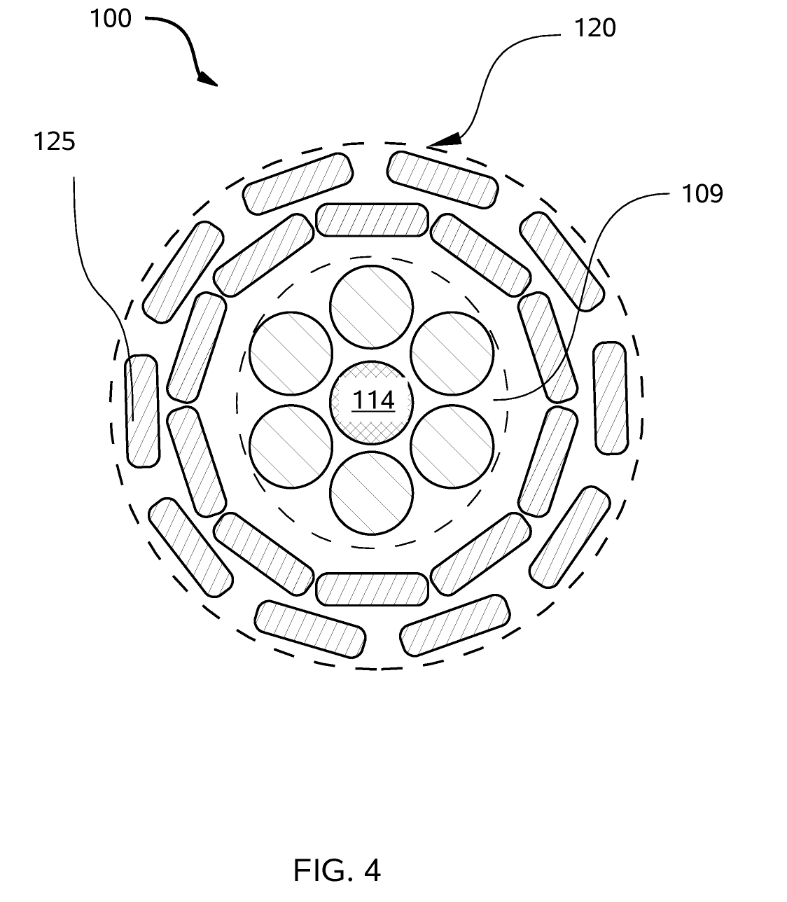

According to another aspect of the present invention, the interior cord may also be an electric or an electronic component. By electric component, it has to be understood any kind of electric conductive material such as a conductive electric cable or wire 114. By electronic component, it has to be understood a television cable, an optic-fiber cable, a coaxial cable, or the like. As for example, as shown in FIG. 4 the electric cable or wire 114 is surrounded by a plurality of parallel, braided, twisted or woven strands, cables, ropes, wires, coils or laces made of a plurality of parallel, braided, twisted or woven fibers or tapes 109 which is which is then covered by the braided exterior cover of woven HMPE or UHMWPE 125 formed of tapes 120.

The interior cord may have a round or flat profile. An example of flat profile may be the use of the covering device or the coating material for covering or coating a HOMI cable or the like (HDMI for “high definition multi media interface”).

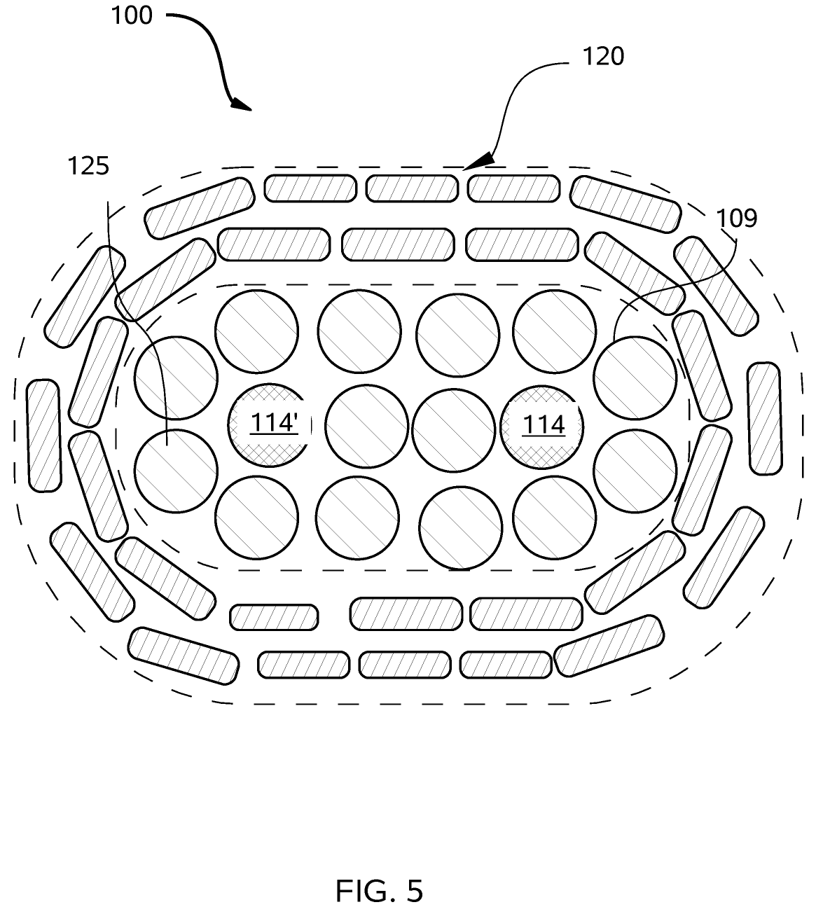

The interior cord may also be a cable wire, which can be used in marine and other applications. As for example, FIG. 5 illustrates a cord 100 that is a cable having two electrical conductors 114 and 114′.

It has to be understood that the cord-like device of the invention may have a round or flat profile.

The covering device or the coating material may be fully or partially intertwined with the interior core, in order to enhance the cohesion between the inside and outside parts of the cord-like device, enhancing solidity and flexibility of the device, reducing its diameter and enhancing security when it is used. The exterior covering device comprised of UHMWPE tapes will enhance the abrasion resistance over multi-fibrillar fibers, and thus may be thinner and hence lighter for a given abrasion resistance performance thus allowing the construction of ropes of smaller diameter and reduced weight.

According to another aspect, the invention also relates to a cord comprising a plurality of parallel, braided, twisted or woven strands, cables, ropes, wires, coils or laces made of a plurality of parallel, braided, twisted or woven tapes. The tapes comprise high molecular weight polyethylene unitary filaments with continuous and coherent structure, providing to the cord higher strength and resistance.

Preferably, the cord may further comprise fibers and/or tapes made of at least one polymer selected from the group consisting of ultra-high molecular weight polyethylene, polyethylene, polypropylene, polyamide, polyester, aromatic polyamide, and aromatic copolyester.

In other words, the cord of the invention may be made of any sorts of strands or fibers known in the art of cords intermingled with tapes of UHMWPE.

To ensure a higher strength, the strands or fibers may be preferably made of at least one polymer selected from the group consisting of ultra-high molecular weight polyethylene, polyethylene, polypropylene, polyamide, polyester, aromatic polyamide, aromatic copolyester and combinations thereof.

The cord of the invention described above may be of course covered by the covering device or the coating material of the invention to ensure higher abrasion resistance, to reduce the volume of the cord; and in some occasions to provide a floating capability to the cord.

According to another aspect, the invention relates to a process for the making of the cord like device defined above. The process comprises the step of providing an interior core, which can be the cord of the invention (including UHMWPE tapes) or any kind of interior cords known in the art or defined above. The covering device or the coating material is then applied around the interior cord.

The covering device may have the form of a tape of UHMWPE. The tape is applied around the interior cord as a bandage.

### EXAMPLES

As an example of the present invention, a new line of ropes with superior abrasion resistance in comparison to existing ropes, has been made.

The higher abrasion resistance of the ropes is attained through the incorporation in the rope of an outside braided layer which is constructed with high strength UHMWPE unitary tapes.

A high strength UHMWPE tape of this application is unitary in the form of a narrow strip or filament with a continuous coherent structure in which the fibers are held together intrinsically by molecular entanglements unlike the multifilament fibers obtained by melt for example, solution or gel-spinning and used in rope manufacturing in which the fibers are loose and separate in their lateral directions. It has been found that such unitary UHMWPE tapes are resistant to fibrillation, have a superior abrasion and fraying resistance in comparison to the multifilament fibers of polyamide, polyester, polyethylene, polypropylene and aromatic polyamides and polyesters used in rope manufacturing and can be braided into smaller diameter and lighter constructions.

Other applications for such HMWPE tapes, and more particularly high strength UHMWPE tape is to form biocompatible and durable covering for a medical or bioimplantable cord or device that deploys as the inner member natural tendons or ligaments, as well as biopolymers and synthetic analogs thereof, which may be desirable, for example in spinal applications.

For example, a braid construction of UHMWPE tape 0.05 mm thick and 3.00 mm wide had a total thickness of 1.00 mm. The thickness of the braid construction could be modified with the thickness of the UHMWPE tape that was used, the number of tapes incorporated in the braid structure in twisted or untwisted form and the braiding pattern.

Ropes made with fibers of ultra high molecular weight polyethylene and aromatic polyamides and polyesters have superior strength to weight performance as compared to metal wires. However, their strength is reduced with abrasion wear, chaffing and soil and dirt contamination and requires a sheath or cover with abrasion resistance to protect the high strength core component or the rope itself. Protection of such high performing fibers with an abrasion resistant braided construction of UHMWPE unitary tapes of this invention is beneficial against external and other environmental factors.

This invention also relates to the use of high strength UHMWPE unitary tapes in woven, braided and knitted structures, such as:

a. A woven webbing product in which the structural element is a unitary fibrillar tape of UHMWPE (as compared to a multifilament UHMWPE fibrillar product).

b. A woven webbing product comprised of two outside layers made of woven webbings of UHMWPE in which the structural element is a unitary fibrillar tape or a multifilament fiber and one internal multilayer component that is comprised of uniaxially oriented UHMWPE fibrillar reinforcing tapes, the total layered structure when bound together having an enhanced load bearing capacity that depends on the load bearing performance of the two outside woven layers and the number of the UHMWPE reinforcing tapes comprising the internal multilayer component.

c. A woven webbing product comprised of two outside layers of woven webbings of a polymer multifilament fiber such as a polyamide, polyester, polypropylene and an internal multilayer component that is comprised of UHMWPE fibrillar reinforcing tapes, the total layered structure when bound together having an enhanced load bearing capacity that depends on the load bearing performance of the outside woven layers and the number of the number of the UHMWPE reinforcing tapes comprising the inside multilayer component.

d. A homogeneous braided or woven product, comprised of a continuous outside sheath of an UHMWPE unitary tape or multifilament fiber and a core multilayer comprised of a plurality of UHMWPE fibrillar reinforcing tapes, in twisted or untwisted form, having an enhanced load bearing capacity that depends on the load bearing performance of the outside sheath layer and the number of the UHMWPE reinforcing tapes that comprise the core.

e. A homogeneous braided or woven product comprised of a continuous exterior sheath of a UHMWPE unitary tape or multifilament fiber and a core multilayer comprised of a plurality of high strength tapes, such as aromatic polymers such as Vectran®.

The concentration of the UHMWPE in the sheath as well as the width of the UHMWPE tape can be varied to adjust the abrasion resistance of the braided product to meet various requirements. A sheath made of 100% UHMWPE tape will have a superior abrasion resistance compared to a sheath made with 30% UHMWPE and 70% polyester. A braided product with a large diameter will have a better abrasion resistance when the UHMWPE tape in the sheath is wider e.g. 2.5 mm as compared to 1.0 mm.

The load bearing capacity of the tape reinforced woven and braided structures, varies with the number of the tape elements used. The UHMWPE tapes can be made to stand various breaking loads. Assuming that a given UHMWPE tape breaks under a load of 100 Lbs, then a woven or braided structure comprised of ten tapes for reinforcement or load-bearing purposes can be made to break at 1000 lbs, excluding the load bearing capacity of the two woven external layers or the braided sheath surrounding the UHMWPE reinforcing tapes. Considering that each of the two external braided layers can have a breaking load of 250 Lbs, the breaking performance of the entire braided structure is 1500 Lbs. for a small thickness increase of 0.5 mm.

Such woven structures have the following features: Enhanced load bearing performance, High load bearing performance to weight ratio, Superior abrasion resistance, Not water absorbing, Chemical Resistance and UV Resistant.

The covering device or coating material of the invention may be used for: ropes, cord, protective sheath for ropes, lines, belts, webbings, protective siding, electronic components, and the like.

### Example 1

A braid construction with the unitary UHMWPE tape of this invention (0.05 mm thick and 3.00 mm wide) was made as an outside abrasion protection layer to a high strength core component of braided Dyneema® polyethylene fibers having a diameter of about 0.375 in (or 9.53 mm) and with an typical tensile strength of about 18,000 lbs. The rope product was firm and looked like wire cable. The weight of the braid construction with unitary UHMWPE tapes was about 10% of the total weight of the rope.

With the strength of the core component unchanged, the rope product featured the combined properties of the superior abrasion resistance of the outside UHMWPE braided component, the high breaking strength of the core component and other advantageous properties such as UV and chemical resistance. Moreover, with both the outside and core braids made of UHMWPE polymers, polymers with a lower density than water, the rope product was buoyant.

### Example 2

A braid construction with the unitary UHMWPE tape of this invention (0.05 mm thick and 3.0 mm wide) was used as an outside layer to a high strength core component of braided aromatic polyamide (Kevlar®) fibers having a diameter of 0.5 in (12.7 mm). The UHMWPE tapes were braided snugly over the Kevlar® core component. The resultant rope product had a diameter 0.33 in (8.38 mm), was firm and looked like a wire cable.

With the strength of the Kevlar® core unchanged, the rope product featured the combined properties of the excellent mechanical properties of Kevlar® in terms of breaking strength, low extension and negligible creep with the superior abrasion wear resistance of the exterior UHMWPE braided component that Kevlar® lacks.

### Example 3

A braid of unitary UHMWPE tapes of this invention (0.05 mm thick and 3.0 mm wide) was used over a 0.5 in. (12.7 mm) double braided Nylon rope construction. The weight fraction of the UHMWPE exterior component was approximately 9% of the total rope weight. The combination of the UHMWPE braided structure of this application over the double braided nylon allowed the production of a floating rope featuring the good shock absorbing characteristics and high elongation of the nylon core with the superior abrasion resistance, excellent UV resistance and non-water absorption behavior of UHMWPE.

### Example 4

A braid of unitary UHMWPE tapes (0.05 mm thick and 3.0 mm wide) was used over a 0.5 in (12.7 mm) double braided multifilament polypropylene construction. The combination of the UHMWPE braided structure of this application over the double braided multifilament polypropylene core allowed the production of non-water absorbing and light floating rope also featuring superior abrasion resistance and excellent UV resistance that polypropylene lacks on its own.

Accelerated abrasion testing was performed on various constructions with and without the UHMWPE tape cover of this invention under load against rotated abrasive surfaces with roughness exceeding 60 micrometers. Ropes with an outside braid construction of unitary UHMWPE tapes of this invention outperformed all ropes in which the outside braid was constructed of a traditional fiber such as nylon, polypropylene, and even Dyneema®. The weight loss of a rope of this invention was about 6.5 times less in comparison to a rope with an outside braid of nylon, about 8.4 times less in comparison to a rope with an outside braid of polypropylene and about 1.5 times less in comparison to a Dyneema® construction over the same length of time, 10 hours testing time for example. Noteably, the UHMWPE tapes did not fray during this test, while all the other constructions did. Accordingly, it is expected the actual useful life of the inventive product will greatly exceed comparable uncovered ropes by a much greater factor than the above weight loss ratios.

### Example 5

Hollow braid constructions of unitary UHMWPE tapes were prepared in different diameters, e.g. 0.375, 0.5 and 1.0 in (9.52; 12.7 and 25.4 mm), for covering three strand ropes and other linear products e.g. cables, cords, strands of fibers, pluralities of tapes, and wires and protecting them from wear.

For example, a flexible tubular braid or woven construction of unitary UHMWPE tapes with a diameter of approximately 1 in. was used as the outside layer to make flat “braid-on-core” constructions in which the core was comprised of a number of high strength UHMWPE tapes assembled into a flat multilayer structures from a few to a large number of layers instead of the traditional strands or threads of high strength fibers with round cross section. Using UHMWPE tape that was less than 0.002 in. (0.05 mm) thick and had a breaking strength of for example 100 lbs, a very thin and light flat braid-on-core construction was made in which the core made of a multilayer structure of for example 20 layers, had a breaking load performance of 2000 lbs. The high strength core component could be made with different pluralities of high strength UHMWPE tapes, 5, 10, 20 and higher number of tape layers and incorporates tapes of different polymers for different performances. Flat “braid-on-core” structures can be useful in the manufacturing of thin and strong line products such as slings.

The development of strong, light weight and small diameter ergonomic ropes combining the superior abrasion resistance characteristics of the braided constructions with the unitary UHMWPE tapes of this invention with core components of high strength fibers can be valuable for various uses and applications where external and environmental factors degrade the strength of the rope, and where space and weight limitations are issues of consideration.

Webbings are used commonly for various load-bearing applications such as seat belts, outdoor gear and equipment, belts and tightening straps and in lifting operations such as for pipes, lumber and boats. The load-bearing performance of the webbing depends on the strength of the multifilament fiber and the webbing pattern. Traditionally webbings are made by weaving multifilament fibers of polyamides, polyesters, polypropylene or in combination with fibers of high strength such as aromatic polyamides (such as Kevlar®) for improving the load-bearing performance of the webbing.

### Example 6

### Laminates

Laminate structures are a form of composite structures combining certain mechanical performance. For enhanced mechanical performance, the laminates are reinforced with traditional and high performance multifilament fibers, which are laid in various patterns and configurations between the laminating layers.

The laminate structures of the present invention relates to the use of unitary fibrillar reinforcing tapes of UHMWPE for the reinforcement of composite structures. More particularly, the laminate structures comprised of one or more layers of thermoplastic non-woven or woven sheet and one or more layers of unitary uniaxially oriented UHMWPE fibrillar reinforcing tapes in woven and nonwoven form.

A feature of the unitary UHMWPE reinforcing tapes is that the fibers in their fibrillar structure are bound intrinsically together without voids between the fibers and without the need for binding media. This allows the construction of less bulky and more flexible laminate structures. Said reinforcement tapes are less susceptible to fraying than multifilament reinforcing fibers.

Having a larger surface area, the said reinforcing tapes promote better adhesion in comparison to multifilament fibers. UHMWPE reinforcing tapes have widths from 0.1 mm to over 25 mm and greater. In addition, they distribute working loads more uniformly and prevent more effectively the tearing of the non-woven or woven sheet that they are reinforced.

One example of such laminate consists of two Mylar® sheets with said reinforcing tapes in between, the layers being bound with adhesive. Another example involves a woven sheet, such as that of Nylon or polyester, with said reinforcing tapes attached to or sandwiched in between.

Reinforcing tapes may be used alone or in combination with other reinforcing monofilament or multifilament fibers such as Kevlar®. They can also be used with thermosetting types of polymers for more rigid composite structures. Applications of the materials and constructions include: sails, fabric reinforcement, technical apparel outdoor gear, cargo siding and covering, coverings, reinforced plastic paneling among others.

Although the present invention has been explained hereinabove by way of preferred embodiments thereof, it should be pointed out that any modifications to this preferred embodiment within the scope of the appended claims is not deemed to alter or change the nature and scope of the present invention. For example, the cover can be applied or braided under different degrees of tension to fit loosely or tightly and thereby give different degrees of flexibility and rigidity to the cord.

While the invention has been described in connection with a preferred embodiment, it is not intended to limit the scope of the invention to the particular form set forth, but on the contrary, it is intended to cover such alternatives, modifications, and equivalents as may be within the spirit and scope of the invention as defined by the appended claims.

We claim:

1. A covering device having enhanced abrasion resistance properties, said covering device comprising a braided construction of high molecular weight polyethylene unitary filaments in a form of a tape with continuous and coherent structure.

2. The covering device of claim 1, wherein the high molecular weight polyethylene has a molecular weight greater than 300,000.

3. The covering device of claim 2, wherein the high molecular weight polyethylene has a molecular weight greater than 3 millions.

4. A cord-like device having enhanced abrasion resistance properties, said device comprising an interior cord surrounded by an exterior covering, said exterior covering comprising an exterior braided construction of high molecular weight polyethylene tape.

5. The cord-like device of claim 4, wherein the high molecular weight polyethylene has a molecular weight greater than 300,000.

6. The cord-like device of claim 5, wherein the high molecular weight polyethylene has a molecular weight greater than 3 millions

7. The cord-like device of claim of claim 4 wherein the high molecular weight polyethylene tape that forms the exterior braided construction is a unitary tape having a continuous and coherent structure.

8. The cord-like device of claim of claim 7 wherein the high molecular weight polyethylene tape that forms the exterior braided construction is an uniaxially oriented UHMWPE fibrillar tape.

9. The cord-like device of claim 7, wherein the high molecular weight polyethylene has a molecular weight greater than 300,000.

10. The cord-like device of claim 7, wherein the high molecular weight polyethylene has a molecular weight greater than 3 millions.

11. The cord-like device of claim 8, wherein the high molecular weight polyethylene has a molecular weight greater than 3 millions.

12. The cord-like device of claim 6, wherein the interior cord comprises a plurality of reinforcing structure selected from the group consisting of fibers and tapes defining one or more strands, ropes, cables, wires, coils or laces.

13. The cord-like device of claim 4, wherein the interior cord comprises a reinforcing structure selected from the group consisting parallel, braided, twisted fibers, woven fibers and tapes.

14. The cord-like device of claim 13 wherein the fibers or tapes are high strength polymer fibers or tapes.

15. The cord-like device of claim 14, wherein the high strength fibers or tapes are made of at least one of metal and metal wires.

16. The cord-like device of claim 13, wherein the fiber, and tapes are high strength multifilament fibers or tapes comprising at least one polymer selected from the group consisting of ultra-high molecular weight polyethylene, polyethylene, polypropylene, polyamide, polyester, aromatic polyamide, and aromatic copolyester.

17. The cord-like device of claim 5 wherein the interior cord is an electric or an electronic component.

18. The cord-like device of claim 17, wherein the electronic component is at least one of a television cable, an optic-fiber cable and a coaxial cable.

19. The cord-like device of claim 11, wherein the interior cord comprises a reinforcing structure selected from the group consisting parallel, braided, twisted fibers, woven fibers and tapes the fiber, and tapes are high strength multifilament fibers or tapes, said fibers or tapes being formed of at least one polymer selected from the group consisting of ultra-high molecular weight polyethylene, polyethylene, polypropylene, polyamide, polyester, aromatic polyamide, and aromatic copolyester.

20. A process for the making of a cord-like device as defined in claim 9, said process comprising the steps of:
a) providing the interior cord; and,
b) applying the exterior covering around the interior cord to form the cord-like device.
